(19) United States
(12) Patent Application Publication
(10) Pub. No.: US 2023/0315654 A1
(43) Pub. Date: Oct. 5, 2023

(54) METHOD OF RING ALLREDUCE PROCESSING

(71) Applicant: Intel Corporation, Santa Clara, CA (US)

(72) Inventors: Guokai Ma, Shanghai (CN); Zhouhai Ye, Shanghai (CN); Feng Zou, Shanghai (CN); Xiaojie Deng, Shanghai (CN)

(73) Assignee: Intel Corporation, Santa Clara, CA (US)

(21) Appl. No.: 18/250,515

(22) PCT Filed: Nov. 30, 2020
(86) PCT No.: PCT/CN2020/132818

§ 371 Date: Apr. 25, 2023

(51) Int. Cl. G06F 13/16; G06F 15/173

(52) U.S. Cl. CPC G06F 13/1673; G06F 15/17375

(57) ABSTRACT

A method of performing ring allreduce operations is disclosed. The method includes sending a chunk of a message in a receive buffer at a current index of a send buffer to a next node in a virtual ring of nodes, receiving a chunk of the message from a previous node in the virtual ring of nodes and store the chunk at the current index of the receive buffer, and reducing a chunk in a send buffer at a previous index of the receive buffer and a chunk in the receive buffer at a previous index of the receive buffer and storing a result at the previous index of the receive buffer. The method includes repeating the sending, receiving and storing, and reducing and storing steps until all chunks of the message are reduced, and sending reduced chunks to the next node and receive reduced chunks from the previous node.

### CLAIM OF PRIORITY

This application claims, under 35 U.S.C. § 371, the benefit of and priority to International Application No. PCT/CN2020/132818, filed Nov. 30, 2020, titled METHOD OF RING ALLREDUCE PROCESSING, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments relate generally to data processing, and more particularly, to improving performance of ring allreduce processing in computing systems.

### BACKGROUND

Allreduce is a commonly used message passing interface (MPI) operation used for data parallelism in training deep learning models with multiple computation units. Allreduce implemented in training deep learning models often operates on messages having very large sizes and is constrained by the number of computation units that can be used. For a typical neural network workload, a message size is approximately 400 megabytes (MBs) and only one core of a computation unit (such as a graphics processing unit (GPU) or a central processing unit (CPU)) can be dedicated to each MPI operation without losing too much computing capability for a neural network workload.

In some computing networks (such as 10 gigabyte (GB) Ethernet), a ring allreduce method is suitable for handling messages with very large sizes. This is partly because the ring allreduce method always has the same sender node and receiver node in each step, making network traffic predictable. However, due to limits of computer architectures, the ring allreduce method is not optimal in terms of network bandwidth utilization. For each step in a reduce-scatter stage, two chunks of a message need to be reduced together. During the reduce time, there is no network traffic between nodes because each computation step has a data dependency on a communications result that must be completed before the computation starts, and communications between nodes cannot start again until the computation is finished. Thus, no overlap of communication and computation is possible, thereby negatively affecting system performance.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 is an example diagram of prior art ring allreduce processing.

FIGS. 2A through 2G are example diagrams of prior art ring allreduce processing.

FIGS. 3A and 3B are flow diagrams of a method of double buffer ring allreduce processing according to some embodiments.

FIGS. 4A through 4I are example diagrams of double buffer ring allreduce processing according to some embodiments.

FIG. 5 is a schematic diagram of an illustrative electronic computing device to perform a method of double buffer ring allreduce processing according to some embodiments.

### DETAILED DESCRIPTION

Implementations of the disclosure provide a double buffer technique for removing the dependencies between the communication and computation steps of a known ring allreduce method. In embodiments of the present invention, the communication and computation steps are overlapped and the computation steps do not result in additional processing overhead. This results in improved processing time for allreduce operations, thereby also improving bandwidth utilization.

Many parallel applications require accessing reduced results across all processes rather than just a root process. In a similar complementary style of MPI allgather to MPI gather, MPI allreduce reduces values and distributes the results to all processes. The function prototype has the following format:

```
MPI_Allreduce (
  Void* send_data,
  Void* recv_data,
  Int count,
  MPI_Datatype datatype,
  MPI_Op op,
  MPI_Comm communicator)
```

The function MPI_allreduce is identical to MPI_reduce with the exception that it does not need a root process ID (since the results are distributed to all processes).

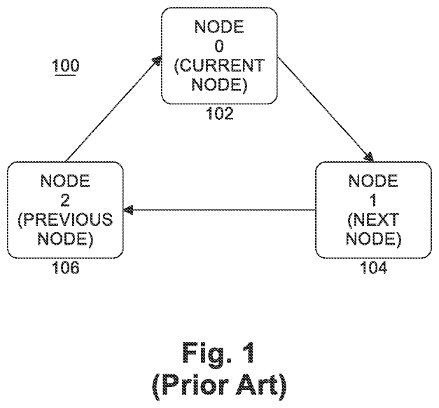

FIG. 1 is an example diagram of prior art ring allreduce processing. In arrangement 100, three nodes are shown: node 0 102, node 1 104, and node 2 106. In this simple example, only three nodes are shown, but any number of nodes may be used. As used herein, a node represents a computing device such as a core of a CPU or GPU, or other circuitry used for computing. Ring allreduce processing typically includes sending data from a first node (e.g., node 0 102) to a second node (e.g., node 1 104), sending data from the second node (e.g., node 1 104) to a third node (e.g., node 2 106), and sending data from the third node (e.g., node 2 106) to the first node (e.g., node 0 102). Thus, in this architecture communication among nodes takes place around the ring of nodes.

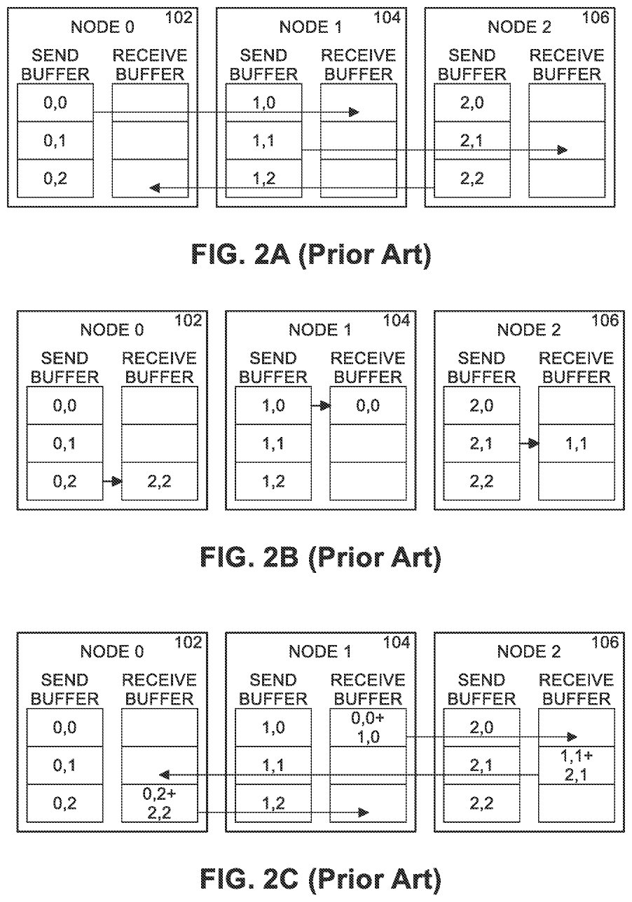

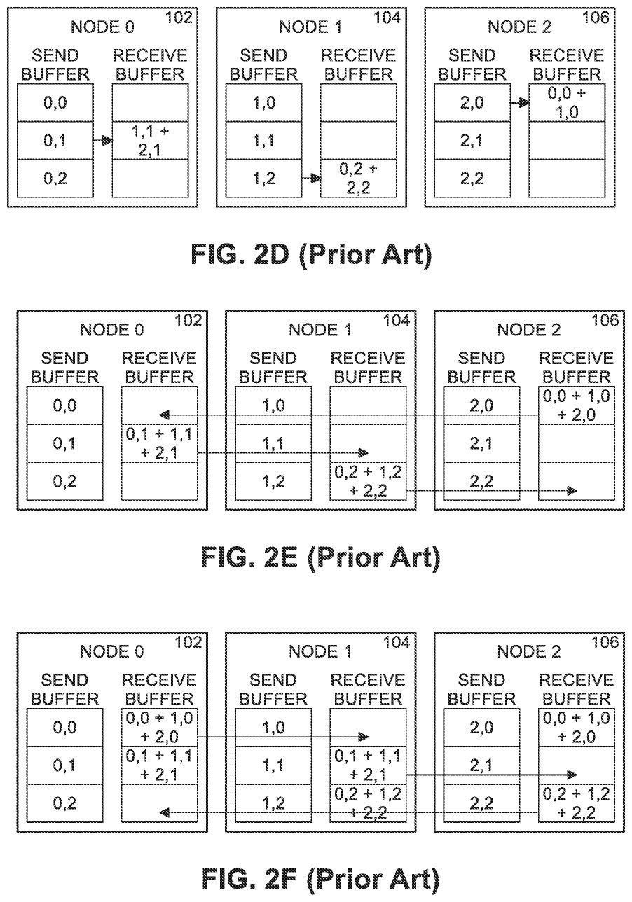

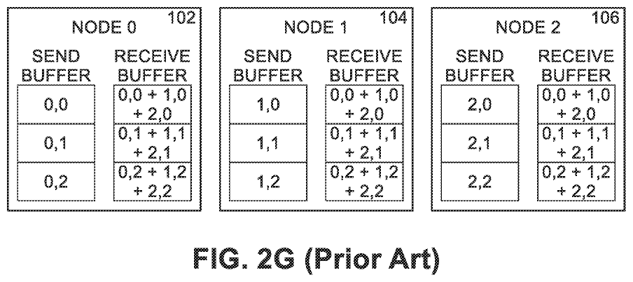

FIGS. 2A through 2G are example diagrams of prior art ring allreduce processing. For the simple example architecture of three nodes shown in FIG. 1, FIGS. 2A through 2G show how the known ring allreduce method works. For three nodes, the ring allreduce method requires four communications steps and two computation steps. FIG. 2A shows a first communication step where node 0 102 sends data to node 1 104, node 1 104 sends data to node 2 106, and node 2 106 sends data to node 0 102. FIG. 2B show a first computation step where node 0 102, node 1 104, and node 2 106 each perform a computation. The steps shown in FIG. 2B cannot be started before the steps shown in FIG. 2A are completed. Similarly, the second communication step shown in FIG. 2C cannot be started before the computation step shown in FIG. 2B is completed, and so on through FIG. 2F. Thus, the steps of the FIGS. 2A->2B->2C->2D->2E->2F must be performed in order. FIG. 2G shows the results of the communications and computation steps. Since no overlapping of computation steps occurs with communication steps, this method is inefficient.

Embodiments of the present invention overcome this deficiency. Instead of evenly separating a message into N chunks (where N is the number of nodes, N being a natural number) and send/reduce these chunks in a ring fashion, as illustrated above in FIGS. 1 and 2, embodiments of the present invention evenly separate the message into 2*N chunks. Like the ring method, each node picks chunks to run over the ring to collect partial reduced values. However, in an embodiment each node picks two chunks to run over the ring, instead of one chunk as in the typical ring method. Each chunk needs to be reduced with the data on a node received by that node, so the communication step needs to wait for the computation step to finish. But, according to embodiments, since each node pick two chunks to run through the ring, one chunk can be transmitted while the other chunk is being reduced. Since these two chunks are independent of each other, such parallelism won't cause data contention. Thus, embodiments providing this double buffer ring can overlap the reduce computation step with the communication step to better utilize network bandwidth and improve allreduce processing performance.

In embodiments, all nodes split the payload of the message evenly into chunks, wherein the number of chunks is equal to two times the number of nodes (2*N). The chunks are numbered from 0 to 2*N−1, where N is the number of nodes. All nodes are arranged in a virtual ring (e.g., node 0 sends chunks to node 1, node 1 sends chunks to node 2, . . . node N−1 sends chunks to node 0). Each node starts from a different even-numbered chunk of the message. For example, node 0 starts from chunk 0, node 1 starts from chunk 2, . . . node N−1 starts from chunk 2*(N−1). In a first initialization step, each node sends a chunk to the next node in the ring, and each node receives a chunk from a previous node in the ring. This populates the first chunk of a double buffer technique at each node (e.g., chunk number 0 at node 0, chunk number 2 at node 1, etc.). At a second initialization step, each node sends a new chunk (e.g., the current chunk number—1) to the next node in the ring. In parallel, the next node reduces the chunk received at the first step with the local chunk of the same index in the send buffer. This populates the second chunk of a double buffer technique at each node. Once each node is populated with two chunks, each node in parallel sends the chunk just reduced to the next node and receives a new chunk from the previous node. This is repeated until all chunks have been fully reduced. Finally, each node passes fully reduced chunks along the ring until the fully reduced chunks have been propagated to all nodes.

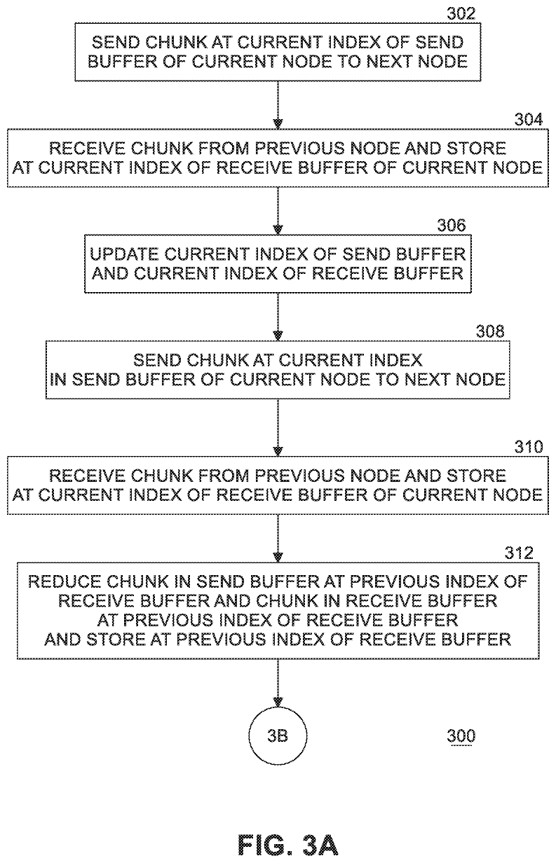

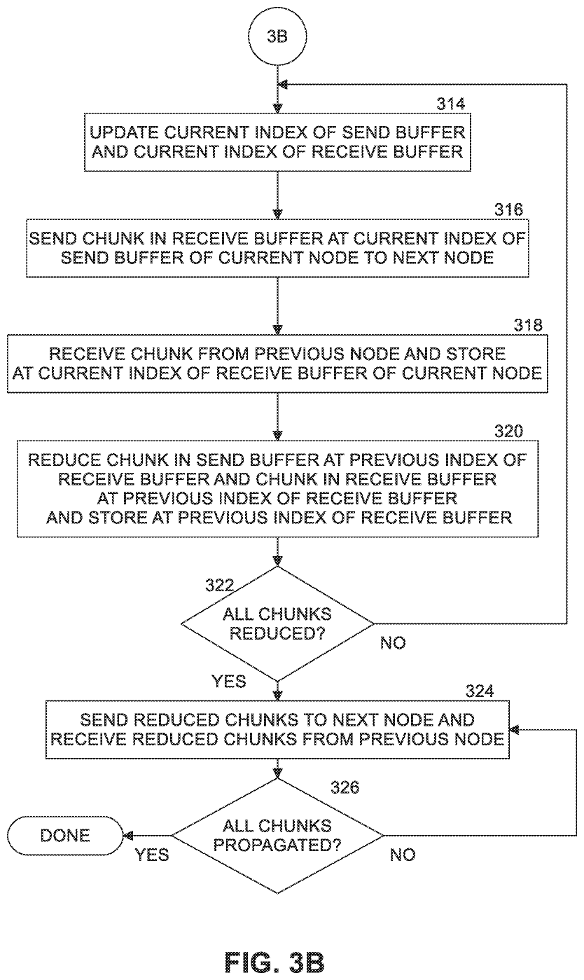

FIGS. 3A and 3B are flow diagrams of a method 300 of double buffer ring allreduce processing for very large message sizes, according to some embodiments. As used herein, a double buffer means a buffer used for ring allreduce processing that has twice the number of entries in the buffer as a prior art buffer. The processing steps of FIGS. 3A and 3B are performed simultaneously by each node of the ring. At block 302, a current node (e.g., the node performing the processing steps of FIGS. 3A and 3B) sends a chunk at a current index of a send buffer of the current node to the next node in the ring. At block 304, the current node receives a chunk from the previous node in the ring and stores the received chunk at a current index of a receive buffer of the current node. This populates a first chunk at the current node during a first initialization step. At block 306, the current node updates the current index of the send buffer of the current node and the current index of the receive buffer. In an embodiment, updating the current index comprises decrementing the current index modulo the number of nodes*2.

At block 308, the current node sends a chunk at the current index in the send buffer of the current node to the next node in the ring. At block 310, the current node receives a chunk from the previous node in the ring and stores the received chunk at the current index of the receive buffer of the current node. This populates a second chunk at the current node during a second initialization step. At block 312, the current node reduces the chunk in the send buffer at the previous index of the receive buffer and the chunk in the receive buffer at the previous index of the receive buffer and stores the result at the previous index of the receive buffer. Processing continues with block 314 of FIG. 3B.

At block 314 of FIG. 3B, the current node updates the current index of the send buffer and the current index of the receive buffer. At block 316, the current node sends the chunk in the receive buffer at the current index of the send buffer of the current node to the next node. At block 318, the current node receives a chunk from the previous node and stores the received chunk at the current index of the receive buffer of the current node. At block 320, the current node reduces the chunk in the send buffer at the previous index of the receive buffer and the chunk in the receive buffer at the previous index of the receive buffer and stores the result at the previous index of the receive buffer. At block 322, if not all chunks of the receive buffer at the current node have been reduced, processing continues with block 314. If at block 322 all chunks of the receive buffer at the current node have been reduced, then at block 324, the current node sends the reduced chunks to the next node and receives reduced chunks from the previous node. At block 326, if all chunks of the message have been propagated to all nodes, then processing is done. Otherwise, processing continues with block 324.

An example double buffer ring allreduce process running on each node represented as pseudocode according to embodiments is shown below in Table 1. This process works for any number of nodes greater than one.

```
TABLE 1
-------------------------------------------------------------------------------------------------------
© 2020 Intel Corporation
function Double Buffer Ring Allreduce
  // num_nodes is the number of nodes
  // rank is the unique number identifying the node, set by MPI, between 0 and
  num_nodes - 1
  // send_buf is the buffer to be reduced
  // recv_buf is the buffer to store the reduced value
  send_rank = rank + 1 (mod num_nodes)
  recv_rank = rank - 1 (mod num_nodes)
  send_chunk = rank * 2 − 0 (mod num_nodes * 2)
  recv_chunk = send_chunk − 2 (mod num_nodes * 2)
  for i = 0...(num_nodes - 2) * 2
    if i is 0, do the following in parallel:
        send send_chunk of send_buf to send_rank
        receive chunk from recv_rank and store to recv_chunk of recv_buf
    elseif i is 1, do the following in parallel:
        send send_chunk of send_buf to send_rank
        receive chunk from recv_rank and store to recv_chunk of recv_buf
        reduce prev_recv_chunk of send_buf and recv_buf together, store in
      recv_buf
    elseif i is neither 0 or 1, do the following in parallel:
        send send_chunk of recv_buf to send_rank
        receive chunk from recv_rank and store to recv_chunk of recv_buf
        reduce prev_recv_chunk of send_buf and recv_buf together, store in
      recv_buf
    endif
    prev_recv_chunk = recv_chunk
    send_chunk = send_chunk − 1 (mod num_nodes * 2)
    recv_chunk = recv_chunk − 1 (mod num_nodes * 2)
  endfor
  for i = 0...(num_nodes - 2) * 2
    if i is 0, do the following in parallel:
        send send_chunk of recv_buf to send_rank
        receive chunk from recv_rank and store to recv_chunk of recv_buf
        reduce prev_recv_chunk of send_buf and recv_buf together, store in
      recv_buf
    else, do the following in parallel:
        send send_chunk of send_buf to send_rank
        receive chunk from recv_rank and store to recv_chunk of recv_buf
    endif
    send_chunk = send_chunk − 1 (mod num_nodes * 2)
    recv_chunk = recv_chunk − 1 (mod num_nodes * 2)
  endfor
end function
```

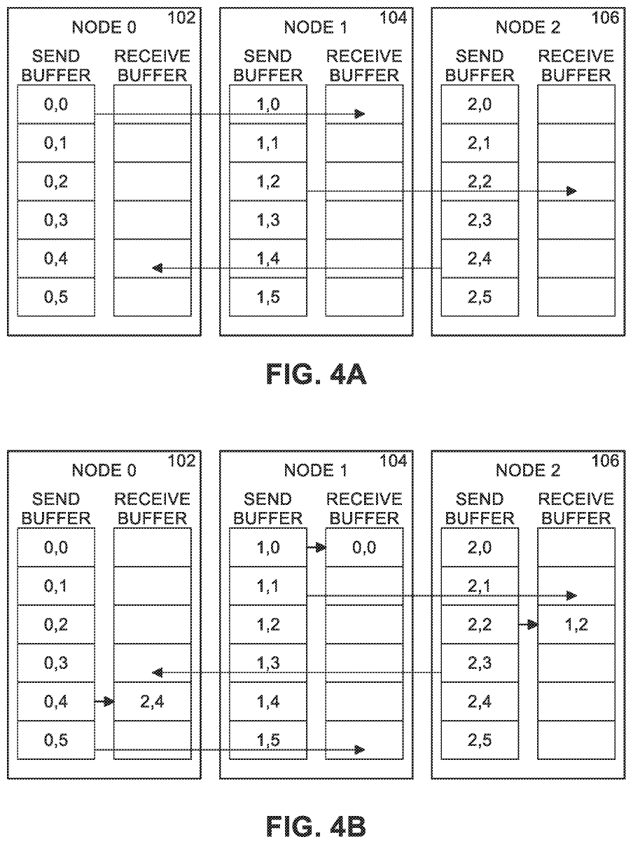

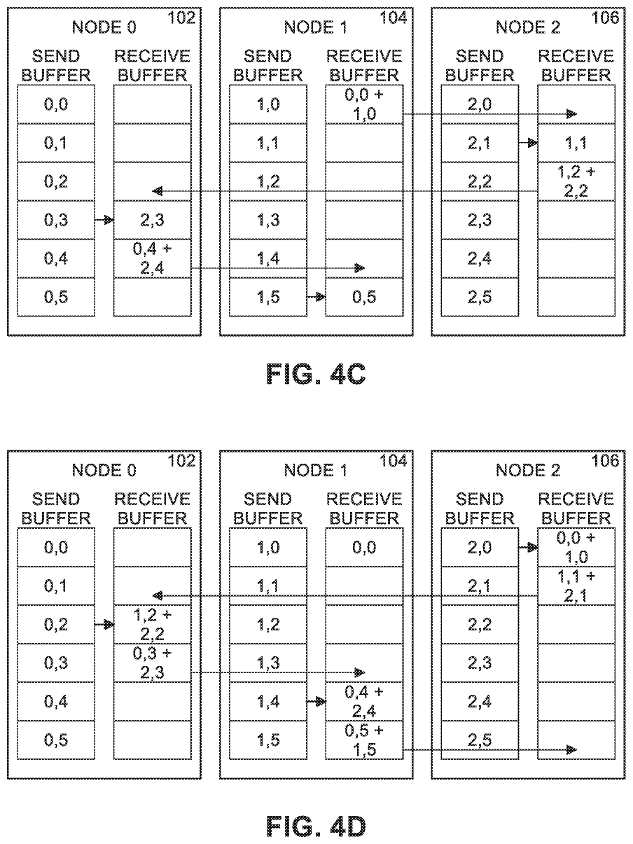

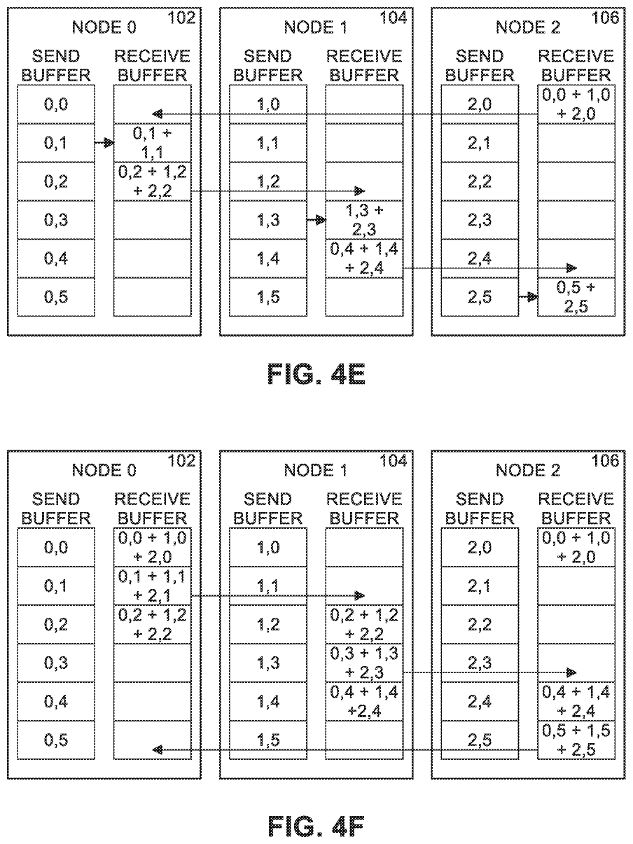

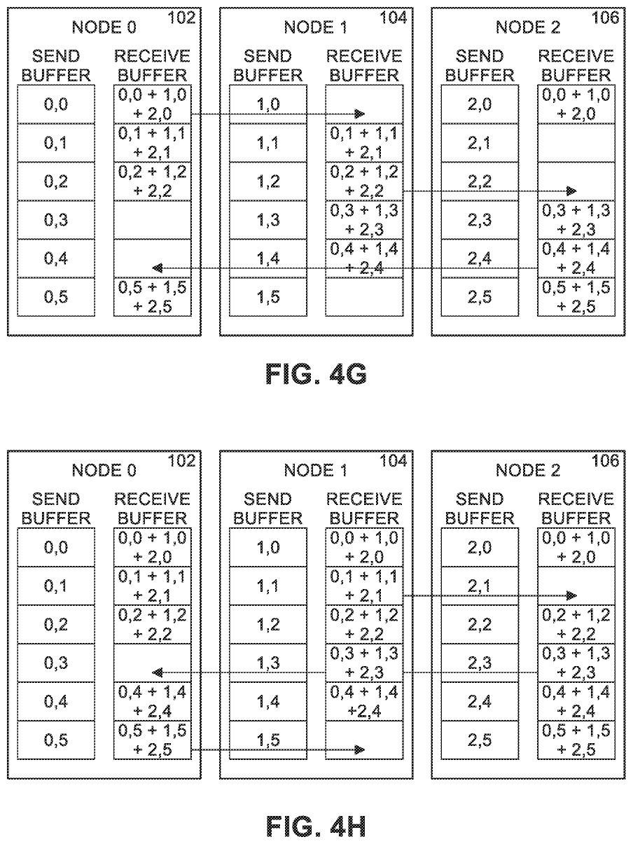

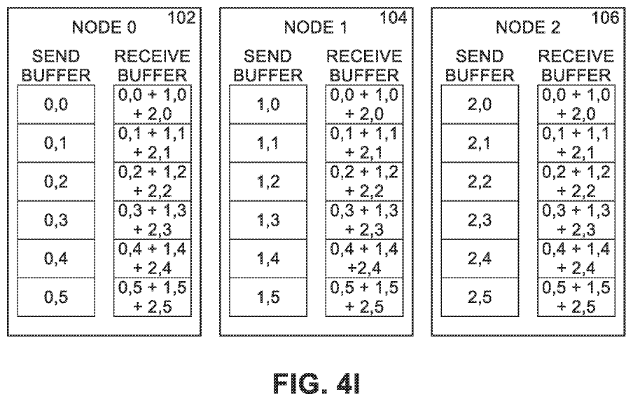

FIGS. 4A through 4I are example diagrams of double buffer ring allreduce processing according to some embodiments. At the first initialization step shown in FIG. 4A, node 0 102 sends a chunk from send buffer (0,0) of node 0 to receive buffer (1,0) of node 1 104, node 1 104 sends a chunk from send buffer (1,2) of node 1 to receive buffer (2,2) of node 2 106, and node 2 sends a chunk from send buffer (2,4) of node 2 to receive buffer (0,4) of node 0. At the second initialization step shown in FIG. 4B, node 0 102 sends a chunk from send buffer (0,5) of node 0 to receive buffer (1,5) of node 1 104, node 1 104 sends a chunk from send buffer (1,1) of node 1 to receive buffer (2,1) of node 2 106, and node 2 sends a chunk from send buffer (2,3) of node 2 to receive buffer (0,3) of node 0, node 0 reduces the chunk at send buffer (0,4) and receive buffer (0,4) (which was received from send buffer (2,4) of node 2 at the previous step), node 1 reduces the chunk at send buffer (1,0) and receive buffer (1,0) (which was received from send buffer (0,0) of node 0 at the previous step), and node 2 reduces the chunk at send buffer (2,2) and receive buffer (2,2) (which was received from send buffer (1,2) of node 1 at the previous step). FIGS. 4C through 4H shows the results of processing blocks 322-324 of FIG. 3B. FIG. 4I shows the final result of reduced chunks propagated to all nodes.

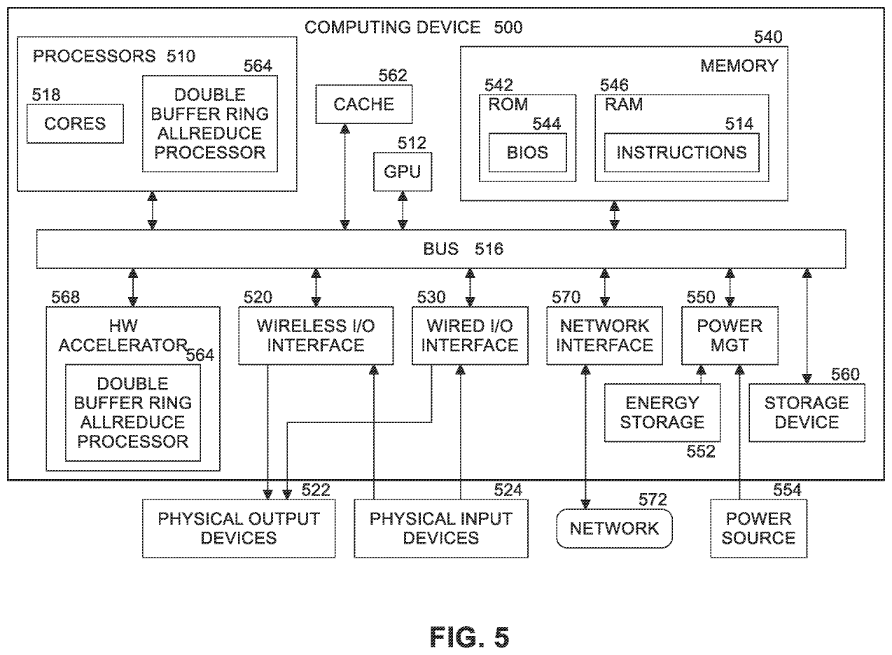

FIG. 5 is a schematic diagram of an illustrative electronic computing device to perform a method of ring allreduce processing for very large message sizes, according to some embodiments. In some embodiments, the computing device 500 includes one or more processors 510 including one or more processors cores 518 and a double buffer ring allreduce processor 564, the double buffer ring allreduce processor 564 to perform double buffer ring allreduce processing, as provided in FIGS. 3A and 3B. In some embodiments, the computing device 500 includes one or more hardware accelerators 568, the one or more hardware accelerators including double buffer ring allreduce processor 564. In some embodiments, one accelerator/CPU operates as one node and provides the interconnection between accelerators/CPUs as connections between the nodes in the virtual ring. In some embodiments, each accelerator/CPU is divided into multiple computing units and a computing unit provides the capabilities of a node in the virtual ring.

In some embodiments, the computing device is to implement double buffer ring allreduce processing, as provided in FIGS. 3A and 3B. In some embodiments, the computing device operates as one or more nodes shown in FIG. 1.

The computing device 500 may additionally include one or more of the following: cache 562, a graphical processing unit (GPU) 512 (which may be the hardware accelerator in some implementations), a wireless input/output (I/O) interface 520, a wired I/O interface 530, memory circuitry 540, power management circuitry 550, non-transitory storage device 560, and a network interface 570 for connection to a network 572. The following discussion provides a brief, general description of the components forming the illustrative computing device 500. Example, non-limiting computing devices 500 may include a desktop computing device, blade server device, workstation, or similar device or system.

In embodiments, the processor cores 518 are capable of executing machine-readable instruction sets 514, reading data and/or instruction sets 514 from one or more storage devices 560 and writing data to the one or more storage devices 560. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 514 may include instructions to implement double buffer ring allreduce processing, as provided in FIGS. 3A and 3B.

The processor cores 518 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 500 includes a bus or similar communications link 516 that communicably couples and facilitates the exchange of information and/or data between various system components including the processor cores 518, the cache 562, the graphics processor circuitry 512, one or more wireless I/O interfaces 520, one or more wired I/O interfaces 530, one or more storage devices 560, and/or one or more network interfaces 570. The computing device 500 may be referred to in the singular herein, but this is not intended to limit the embodiments to a single computing device 500, since in certain embodiments, there may be more than one computing device 500 that incorporates, includes, or contains any number of communicably coupled, collocated, or remote networked circuits or devices.

The processor cores 518 may include any number, type, or combination of currently available or future developed devices capable of executing machine-readable instruction sets.

The processor cores 518 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 516 that interconnects at least some of the components of the computing device 500 may employ any currently available or future developed serial or parallel bus structures or architectures.

The system memory 540 may include read-only memory (“ROM”) 542 and random-access memory (“RAM”) 546. A portion of the ROM 542 may be used to store or otherwise retain a basic input/output system (“BIOS”) 544. The BIOS 544 provides basic functionality to the computing device 500, for example by causing the processor cores 518 to load and/or execute one or more machine-readable instruction sets 514. In embodiments, at least some of the one or more machine-readable instruction sets 514 cause at least a portion of the processor cores 518 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 500 may include at least one wireless input/output (I/O) interface 520. The at least one wireless I/O interface 520 may be communicably coupled to one or more physical output devices 522 (tactile devices, video displays, audio output devices, hardcopy output devices, etc.). The at least one wireless I/O interface 520 may communicably couple to one or more physical input devices 524 (pointing devices, touchscreens, keyboards, tactile devices, etc.). The at least one wireless I/O interface 520 may include any currently available or future developed wireless I/O interface. Example wireless I/O interfaces include, but are not limited to: BLUETOOTH®, near field communication (NFC), and similar.

The computing device 500 may include one or more wired input/output (I/O) interfaces 530. The at least one wired I/O interface 530 may be communicably coupled to one or more physical output devices 522 (tactile devices, video displays, audio output devices, hardcopy output devices, etc.). The at least one wired I/O interface 530 may be communicably coupled to one or more physical input devices 524 (pointing devices, touchscreens, keyboards, tactile devices, etc.). The wired I/O interface 530 may include any currently available or future developed I/O interface. Example wired I/O interfaces include but are not limited to: universal serial bus (USB), IEEE 1394 (“FireWire”), and similar.

The computing device 500 may include one or more communicably coupled, non-transitory, data storage devices 560. The data storage devices 560 may include one or more hard disk drives (HDDs) and/or one or more solid-state storage devices (SSDs). The one or more data storage devices 560 may include any current or future developed storage appliances, network storage devices, and/or systems. Non-limiting examples of such data storage devices 560 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 560 may include one or more removable storage devices, such as one or more flash drives, flash memories, flash storage units, or similar appliances or devices capable of communicable coupling to and decoupling from the computing device 500.

The one or more data storage devices 560 may include interfaces or controllers (not shown) communicatively coupling the respective storage device or system to the bus 516. The one or more data storage devices 560 may store, retain, or otherwise contain machine-readable instruction sets, data structures, program modules, data stores, databases, logical structures, and/or other data useful to the processor cores 518 and/or graphics processor circuitry 512 and/or one or more applications executed on or by the processor cores 518 and/or graphics processor circuitry 512. In some instances, one or more data storage devices 560 may be communicably coupled to the processor cores 518, for example via the bus 516 or via one or more wired communications interfaces 530 (e.g., Universal Serial Bus or USB); one or more wireless communications interfaces 520 (e.g., Bluetooth®, Near Field Communication or NFC); and/or one or more network interfaces 570 (IEEE 802.3 or Ethernet, IEEE 802.11, or Wi-Fi®, etc.).

Processor-readable instruction sets 514 and other programs, applications, logic sets, and/or modules may be stored in whole or in part in the system memory 540. Such instruction sets 514 may be transferred, in whole or in part, from the one or more data storage devices 560. The instruction sets 514 may be loaded, stored, or otherwise retained in system memory 540, in whole or in part, during execution by the processor cores 518 and/or graphics processor circuitry 512.

The computing device 500 may include power management circuitry 550 that controls one or more operational aspects of the energy storage device 552. In embodiments, the energy storage device 552 may include one or more primary (i.e., non-rechargeable) or secondary (i.e., rechargeable) batteries or similar energy storage devices. In embodiments, the energy storage device 552 may include one or more supercapacitors or ultracapacitors. In embodiments, the power management circuitry 550 may alter, adjust, or control the flow of energy from an external power source 554 to the energy storage device 552 and/or to the computing device 500. The power source 554 may include, but is not limited to, a solar power system, a commercial electric grid, a portable generator, an external energy storage device, or any combination thereof.

For convenience, the processor cores 518, the graphics processor circuitry 512, the wireless I/O interface 520, the wired I/O interface 530, the storage device 560, and the network interface 570 are illustrated as communicatively coupled to each other via the bus 516, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In another example, one or more of the above-described components may be integrated into the processor cores 518 and/or the graphics processor circuitry 512. In some embodiments, all or a portion of the bus 516 may be omitted and the components are coupled directly to each other using suitable wired or wireless connections.

Flowcharts representative of example hardware logic, machine readable instructions, hardware implemented state machines, and/or any combination thereof for implementing computing device 500, for example, are shown in FIGS. 3A and 3B. The machine-readable instructions may be one or more executable programs or portion(s) of an executable program for execution by a computer processor such as the processor 510 shown in the example computing device 500 discussed above in connection with FIG. 5. The program may be embodied in software stored on a non-transitory computer readable storage medium such as a CD-ROM, a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although the example program is described with reference to the flowchart illustrated in FIGS. 3A and 3B and the pseudocode of Table 1, many other methods of implementing the example systems 500 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example process of FIGS. 3A and 3B may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is an apparatus to perform ring allreduce operations. The apparatus of Example 1 comprises instructions to send a chunk of a message in a receive buffer at a current index of a send buffer to a next node in a virtual ring of nodes; receive a chunk of the message from a previous node in the virtual ring of nodes and store the chunk at the current index of the receive buffer; reduce a chunk in a send buffer at a previous index of the receive buffer and a chunk in the receive buffer at a previous index of the receive buffer and store a result at the previous index of the receive buffer; repeat the sending, receiving and storing, and reducing and storing steps until all chunks of the message are reduced; and send reduced chunks to the next node and receive reduced chunks from the previous node.

In Example 2, the subject matter of Example 1 can optionally include wherein at a first initialization step, send a chunk at the current index of the send buffer to the next node, receive a chunk from the previous node and store the received chunk at the current index of the receive buffer, and update the current index of the send buffer and the current index of the receive buffer.

In Example 3, the subject matter of Example 2 can optionally include wherein at a second initialization step, send a chunk at the current index of the send buffer to the next node, receive a chunk from the previous node and store the received chunk at the current index of the receive buffer, and reduce a chunk in the send buffer at the previous index of the receive buffer and a chunk in the receive buffer at the previous index of the receive buffer and store a result at the previous index of the receive buffer.

In Example 4, the subject matter of Example 1 can optionally include wherein reducing chunks comprises performing a ring allreduce operation on the chunks.

In Example 5, the subject matter of Example 1 can optionally include wherein the message is comprised of 2*N chunks, where N is a number of nodes in the virtual ring.

In Example 6, the subject matter of Example 1 can optionally include wherein the send buffer comprises 2*N entries and the receive buffer comprises 2*N entries, where N is a number of nodes in the virtual ring.

Example 7 is a method for performing ring allreduce operations. The method of Example 7 can include sending a chunk of a message in a receive buffer at a current index of a send buffer to a next node in a virtual ring of nodes; receiving a chunk of the message from a previous node in the virtual ring of nodes and storing the chunk at the current index of the receive buffer; reducing a chunk in a send buffer at a previous index of the receive buffer and a chunk in the receive buffer at a previous index of the receive buffer and storing a result at the previous index of the receive buffer; repeating the sending, receiving and storing, and reducing and storing steps until all chunks of the message are reduced; and sending reduced chunks to the next node and receive reduced chunks from the previous node.

In Example 8, the subject matter of Example 7 can optionally include wherein at a first initialization step, sending a chunk at the current index of the send buffer to the next node, receiving a chunk from the previous node and storing the received chunk at the current index of the receive buffer, and updating the current index of the send buffer and the current index of the receive buffer.

In Example 9, the subject matter of Example 8 can optionally include wherein at a second initialization step, sending a chunk at the current index of the send buffer to the next node, receiving a chunk from the previous node and storing the received chunk at the current index of the receive buffer, and reducing a chunk in the send buffer at the previous index of the receive buffer and a chunk in the receive buffer at the previous index of the receive buffer and storing a result at the previous index of the receive buffer.

In Example 10, the subject matter of Example 7 can optionally include wherein reducing chunks comprises performing a ring allreduce operation on the chunks.

In Example 11, the subject matter of Example 7 can optionally include wherein the message is comprised of 2*N chunks, where N is a number of nodes in the virtual ring.

In Example 12, the subject matter of Example 7 can optionally include wherein the send buffer comprises 2*N entries and the receive buffer comprises 2*N entries, where N is a number of nodes in the virtual ring.

Example 13 is at least one non-transitory machine-readable storage medium for storing instructions for performing ring allreduce operations. The at least one non-transitory machine-readable storage medium of Example 13 comprises instructions that, when executed, cause at least one processor to at least: send a chunk of a message in a receive buffer at a current index of a send buffer to a next node in a virtual ring of nodes; receive a chunk of the message from a previous node in the virtual ring of nodes and store the chunk at the current index of the receive buffer; reduce a chunk in a send buffer at a previous index of the receive buffer and a chunk in the receive buffer at a previous index of the receive buffer and store a result at the previous index of the receive buffer; repeat the sending, receiving and storing, and reducing and storing steps until all chunks of the message are reduced; and send reduced chunks to the next node and receive reduced chunks from the previous node.

In Example 14, the subject matter of Example 13 can optionally include instructions that when executed further cause the at least one processor to at a first initialization step, send a chunk at the current index of the send buffer to the next node, receive a chunk from the previous node and store the received chunk at the current index of the receive buffer, and update the current index of the send buffer and the current index of the receive buffer.

In Example 15, the subject matter of Example 14 can optionally include instructions that when executed further cause the at least one processor to at a second initialization step, send a chunk at the current index of the send buffer to the next node, receive a chunk from the previous node and store the received chunk at the current index of the receive buffer, and reduce a chunk in the send buffer at the previous index of the receive buffer and a chunk in the receive buffer at the previous index of the receive buffer and store a result at the previous index of the receive buffer.

In Example 16, the subject matter of Example 13 can optionally include wherein reducing chunks comprises performing a ring allreduce operation on the chunks.

In Example 17, the subject matter of Example 13 can optionally include wherein the message is comprised of 2*N chunks, where N is a number of nodes in the virtual ring.

In Example 18, the subject matter of Example 13 can optionally include wherein the send buffer comprises 2*N entries and the receive buffer comprises 2*N entries, where N is a number of nodes in the virtual ring.

Example 19 is an apparatus to perform ring allreduce operations. The apparatus of Example 19 comprises means for sending a chunk of a message in a receive buffer at a current index of a send buffer to a next node in a virtual ring of nodes; means for receiving a chunk of the message from a previous node in the virtual ring of nodes and storing the chunk at the current index of the receive buffer; means for reducing a chunk in a send buffer at a previous index of the receive buffer and a chunk in the receive buffer at a previous index of the receive buffer and storing a result at the previous index of the receive buffer; means for repeating the sending, receiving and storing, and reducing and storing steps until all chunks of the message are reduced; and means for sending reduced chunks to the next node and receive reduced chunks from the previous node.

In Example 20, the subject matter of Example 19 can optionally include wherein at a first initialization step, means for sending a chunk at the current index of the send buffer to the next node, means for receiving a chunk from the previous node and storing the received chunk at the current index of the receive buffer, and means for updating the current index of the send buffer and the current index of the receive buffer.

In Example 21, the subject matter of Example 20 can optionally include wherein at a second initialization step, means for sending a chunk at the current index of the send buffer to the next node, means for receiving a chunk from the previous node and storing the received chunk at the current index of the receive buffer, and means for reducing a chunk in the send buffer at the previous index of the receive buffer and a chunk in the receive buffer at the previous index of the receive buffer and storing a result at the previous index of the receive buffer.

In Example 22, the subject matter of Example 19 can optionally include wherein means for reducing chunks comprises means for performing a ring allreduce operation on the chunks.

In Example 23, the subject matter of Example 19 can optionally include wherein the message is comprised of 2*N chunks, where N is a number of nodes in the virtual ring.

In Example 24, the subject matter of Example 19 can optionally include wherein the send buffer comprises 2*N entries and the receive buffer comprises 2*N entries, where N is a number of nodes in the virtual ring.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. An apparatus comprising:
a processing device; and
a memory device coupled to the processing device, the memory device having instructions stored thereon that, in response to execution by the processing device, cause the processing device to:
send a chunk of a message in a receive buffer at a current index of a send buffer to a next node in a virtual ring of nodes;
receive a chunk of the message from a previous node in the virtual ring of nodes and store the chunk at the current index of the receive buffer;
reduce a chunk in a send buffer at a previous index of the receive buffer and a chunk in the receive buffer at a previous index of the receive buffer and store a result at the previous index of the receive buffer;
repeat sending, receiving, and reducing until all chunks of the message are reduced; and
send reduced chunks to the next node and receive reduced chunks from the previous node.

2. The apparatus of claim 1, comprising instructions stored the memory device that, in response to execution by the processing device, cause the processing device to:
at a first initialization step, send a chunk at the current index of the send buffer to the next node, receive a chunk from the previous node and store the received chunk at the current index of the receive buffer, and update the current index of the send buffer and the current index of the receive buffer.

3. The apparatus of claim 2, comprising instructions stored the memory device that, in response to execution by the processing device, cause the processing device to:
at a second initialization step, send a chunk at the current index of the send buffer to the next node, receive a chunk from the previous node and store the received chunk at the current index of the receive buffer, and reduce a chunk in the send buffer at the previous index of the receive buffer and a chunk in the receive buffer at the previous index of the receive buffer and store a result at the previous index of the receive buffer.

4. The apparatus of claim 1, wherein reducing chunks comprises performing a ring allreduce operation on the chunks.

5. The apparatus of claim 1, wherein the message is comprised of 2*N chunks, where N is a number of nodes in the virtual ring.

6. The apparatus of claim 1, wherein the send buffer comprises 2*N entries and the receive buffer comprises 2*N entries, where N is a number of nodes in the virtual ring.

7. A method comprising:
sending a chunk of a message in a receive buffer at a current index of a send buffer to a next node in a virtual ring of nodes;
receiving a chunk of the message from a previous node in the virtual ring of nodes and store the chunk at the current index of the receive buffer;
reducing a chunk in a send buffer at a previous index of the receive buffer and a chunk in the receive buffer at a previous index of the receive buffer and storing a result at the previous index of the receive buffer;
repeating the sending, receiving, and reducing steps until all chunks of the message are reduced;
sending reduced chunks to the next node and receive reduced chunks from the previous node.

8. The method of claim 7, comprising:
at a first initialization step, sending a chunk at the current index of the send buffer to the next node, receiving a chunk from the previous node and storing the received chunk at the current index of the receive buffer, and updating the current index of the send buffer and the current index of the receive buffer.

9. The method of claim 8, comprising:
at a second initialization step, sending a chunk at the current index of the send buffer to the next node, receiving a chunk from the previous node and storing the received chunk at the current index of the receive buffer, and reducing a chunk in the send buffer at the previous index of the receive buffer and a chunk in the receive buffer at the previous index of the receive buffer and storing a result at the previous index of the receive buffer.

10. The method of claim 7, wherein reducing chunks comprises performing a ring allreduce operation on the chunks.

11. The method of claim 7, wherein the message is comprised of 2*N chunks, where N is a number of nodes in the virtual ring.

12. The method of claim 7, wherein the send buffer comprises 2*N entries and the receive buffer comprises 2*N entries, where N is a number of nodes in the virtual ring.

13. At least one machine-readable storage medium comprising instructions that, when executed, cause at least one processor to at least:
send a chunk of a message in a receive buffer at a current index of a send buffer to a next node in a virtual ring of nodes;
receive a chunk of the message from a previous node in the virtual ring of nodes and store the chunk at the current index of the receive buffer;
reduce a chunk in a send buffer at a previous index of the receive buffer and a chunk in the receive buffer at a previous index of the receive buffer and store a result at the previous index of the receive buffer;
repeat the sending, receiving, and reducing steps until all chunks of the message are reduced; and
send reduced chunks to the next node and receive reduced chunks from the previous node.

14. The machine-readable storage medium of claim 13, wherein the instructions, when executed further cause the at least one processor to:
at a first initialization step, send a chunk at the current index of the send buffer to the next node, receive a chunk from the previous node and store the received chunk at the current index of the receive buffer, and update the current index of the send buffer and the current index of the receive buffer.

15. The machine-readable storage medium of claim 14, wherein the instructions, when executed further cause the at least one processor to:
at a second initialization step, send a chunk at the current index of the send buffer to the next node, receive a chunk from the previous node and store the received chunk at the current index of the receive buffer, and reduce a chunk in the send buffer at the previous index of the receive buffer and a chunk in the receive buffer at the previous index of the receive buffer and store a result at the previous index of the receive buffer.

16. The machine-readable storage medium of claim 13, wherein reducing chunks comprises performing a ring allreduce operation on the chunks.

17. The machine-readable storage medium of claim 13, wherein the message is comprised of 2*N chunks, where N is a number of nodes in the virtual ring.

18. The machine-readable storage medium of claim 13, wherein the send buffer comprises 2*N entries and the receive buffer comprises 2*N entries, where N is a number of nodes in the virtual ring.
